(19) United States
(12) Patent Application Publication
(10) Pub. No.: US 2011/0097813 A1
(43) Pub. Date: Apr. 28, 2011

(54) THREE-DIMENSIONAL LIQUID CHROMATOGRAPHY

(75) Inventors: Masahito ITO, Hitachinaka (JP); Junkichi MIURA, Hitachi (JP); Kisaburo DEGUCHI, Sapporo (JP)

(73) Assignee: HITACHI HIGH-TECHNOLOGIES CORPORATION, TOKYO (JP)

(21) Appl. No.: 12/917,084

(22) Filed: Nov. 1, 2010

Related U.S. Application Data
(63) Continuation of application No. 11/700,844, filed on Feb. 1, 2007, now abandoned.

(30) Foreign Application Priority Data
Feb. 3, 2006 (JP) 2006-026488

(51) Int. Cl. G01N 30/02; B01D 15/08; B01D 15/04

(52) U.S. Cl. 436/161; 210/656; 210/659

(57) ABSTRACT

In a liquid chromatography apparatus, a separation column of intermediate stage is additionally connected between a separation column of first stage and a separation column of second stage. Preferably, a switching unit and a liquid feed unit for mixing and feeding a plurality of solutions are added to improve a separation capability. A three-dimensional liquid chromatography apparatus capable of avoiding the “solution interference” can be realized. Even a complex sample containing a hydrophilic component and a hydrophobic component in a mixed state can be separated and analyzed satisfactorily on-line.

This application is a continuation of U.S. patent application Ser. No. 11/700,844 filed Feb. 1, 2007, which claims priority to Japanese Patent Application No. 2006-026488 filed on Feb. 3, 2006, the disclosure of which, including the specification, drawings and abstract, is incorporated herein by reference in its entirety.

### BACKGROUND OF THE INVENTION

1. Field of the Invention

The present invention relates to a liquid chromatography apparatus. More specifically, the present invention relates to a three-dimensional liquid chromatography apparatus including, for example, a normal-phase, ion-exchange, and reversed-phase separation columns.

2. Description of the Related Art

In a complex biotic sample, a hydrophilic component, a hydrophobic component, and an ionic component are mixed and the molecular weight of each component is distributed over a wide range. Accordingly, there is a limit in separating the components by one type of column. To overcome such a limit, two-dimensional liquid chromatography apparatuses each using a combination of two types of columns operating based on different separation modes are proposed (see Non-Patent Document 1: A. J. Link et al, Nat. Biotechnol. 17, 676 (1999), Non-Patent Document 2: Y. Shen et al, Anal. Chem. 77, 3090 (2005), Non-Patent Document 3: T. Wehr, L C. G C Europe Mar. 2 (2003), and Non-Patent Document 4: P. Dugo et al, Anal. Chem. 76, 2525 (2004)). A column of first stage (first dimension) and a column of second stage (second dimension) used in those known techniques are restricted to a combination of the ion-exchange column (size exclusion column in some cases) and the reversed-phase column.

### SUMMARY OF THE INVENTION

As a result of conducting intensive studies, the inventors have found the following.

Table 1 represents the relationships between three kinds of separation modes (i.e., normal-phase, ion-exchange, and reversed-phase modes) and samples. In Table 1, a mark ◯ means that the sample can be retained (separable), and a mark X means that the sample cannot be retained (non-separable). Although there are in practice samples having intermediate properties, those samples are omitted here for simplicity of the description. As seen from Table 1, in the case of employing the above-mentioned column combination, separation of hydrophilic components such as indicated by sample groups C and D cannot be successfully performed.

TABLE 1

| | Normal-phase | Ion-exchange | Reversed-phase |
|---|---|---|---|
| Sample group | column | column | column |
| A | X | X | ◯ |
| B | X | ◯ | ◯ |
| C | ◯ | ◯ | X |
| D | ◯ | X | X |

A combination of the normal-phase column and the reversed-phase column is required to perform separation and analysis of the biotic sample including the sample groups A-D. In that case, however, an organic solvent used for the component separation in the normal-phase column impedes the component separation in the reversed-phase column. More specifically, when the component separated in the normal-phase column is introduced to the reversed-phase column together with the organic solvent, the component is eluted as it is without being retained on the reversed-phase column or being further separated. In other words, the so-called “solution interference” occurs. For that reason, it is essential to devise some means or contrivance for realizing “solution non-interference” so that the solution used for the component separation in the column of first stage (first dimension) will not impede the component separation in the column of second stage (second dimension).

The simplest method of avoiding the “solution interference” is to perform the component separation and analysis by introducing a solution sample to each of two liquid chromatography apparatuses including the normal-phase column and the reversed-phase column, respectively, or to temporarily fraction a component separated by a liquid chromatography apparatus including the normal-phase column at intervals of a certain time, and after removing an organic solvent, to perform further separation and analysis of the separated component again by using a liquid chromatography apparatus including the reversed-phase column.

As an alternative method, it is also proposed to, instead of removing the organic solvent, dilute the organic solvent eluted from the normal-phase column at a flow rate ratio of 400:1 and to introduce the diluted organic solution into the reversed-phase column (see Patent Document 4). However, that method is not suitable for a high-sensitivity analysis because the separated component is also diluted at a ratio of 400:1.

An object of the present invention is to avoid the “solution interference” in a more satisfactory manner.

In a liquid chromatography apparatus of the present invention, a separation column of intermediate stage is additionally connected between a separation column of first stage and a separation column of second stage. Preferably, a switching unit and a liquid feed unit for mixing and feeding a plurality of solutions are added to improve a separation capability.

According to the present invention, a three-dimensional liquid chromatography apparatus capable of avoiding the “solution interference” can be realized. As a result, even a complex sample containing a hydrophilic component and a hydrophobic component in a mixed state can be separated and analyzed satisfactorily on-line.

### BRIEF DESCRIPTION OF THE DRAWINGS

FIGS. 1A-1C are each a diagram showing the construction and flow passages of a three-dimensional liquid chromatography apparatus according to a first embodiment of the present invention;

FIG. 2 is a table showing a gradient program for a pump used in experiments in relation to the first embodiment;

FIGS. 3A and 3B are each a diagram showing the construction and flow passages of the three-dimensional liquid chromatography apparatus used in the experiments in relation to the first embodiment;

FIGS. 4A and 4B are charts showing the results (reproducibility of retention time) of the experiments in relation to the first embodiment; and

FIG. 5 is a diagram showing the construction and flow passages of a three-dimensional liquid chromatography apparatus according to a second embodiment of the present invention.

### DESCRIPTION OF THE PREFERRED EMBODIMENTS

The above-mentioned and other novel features of the present invention will be described below with reference to the drawings. Note that the drawings are attached merely for the sake of explanation and should not be construed to limit the scope of the present invention.

### First Embodiment

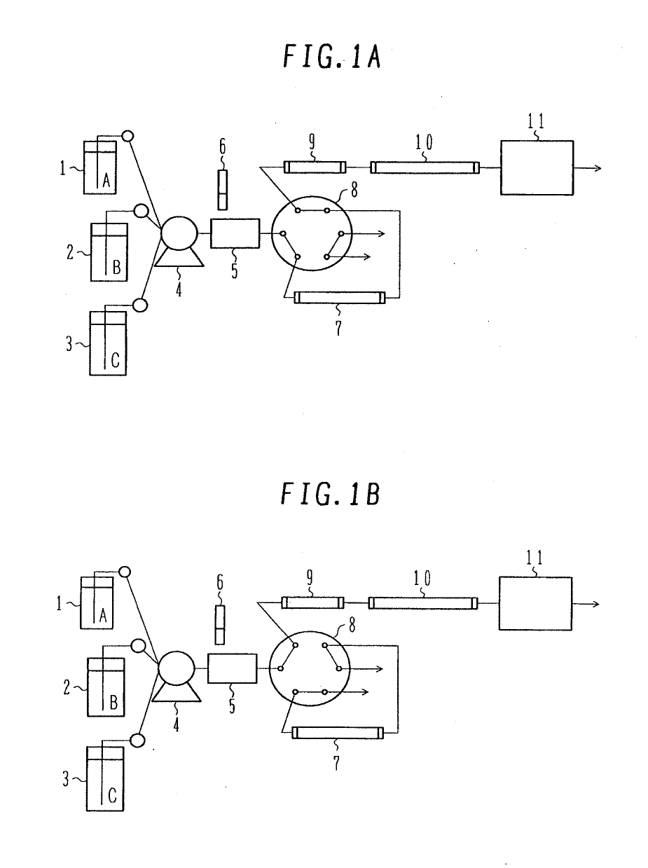

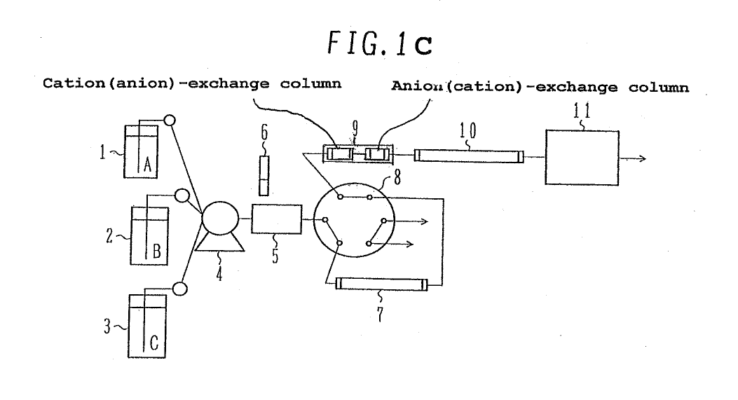

FIG. 1 represents a first embodiment of the present invention and shows a three-dimensional liquid chromatography apparatus having the simplest construction. The functions and operating principles of component units are described below.

The three-dimensional liquid chromatography apparatus of the first embodiment comprises a gradient pump 4, a sample injection unit (means), a normal-phase column 7 serving as a separation column of first stage, a reversed-phase column 10 serving as a separation column of second stage, a 6-way flow passage switching valve 8 serving as a switching unit (means), and a mass spectrometer 11 serving as a detection unit (means) for detecting separated components. In addition, an ion-exchange column 9 serving as a separation column of intermediate stage is connected between the switching unit and the separation column of second stage.

The gradient pump 4 serves as a liquid feed unit (means) for mixing and feeding a plurality of solutions. More specifically, the gradient pump 4 is able to mix an aqueous solution A 1, an organic solvent solution B 2, and an aqueous solution C 3 at a predetermined ratio, and to feed the mixed solution to a flow passage.

The sample injection unit is made up of an auto-sampler 5 and a sample introducing unit 6.

The 6-way flow passage switching valve 8 is a switching unit for introducing a component separated by the separation column of first stage to the separation column of second stage. FIGS. 1A and 1B show flow passages established when the 6-way flow passage switching valve 8 is shifted to different states. In the state of FIG. 1A, the sample injection unit, the normal-phase column 7, the ion-exchange column 9, and the reversed-phase column 10 are connected in series. In the state of FIG. 1B, the sample injection unit, the ion-exchange column 9, and the reversed-phase column 10 are connected in series.

The operation of the three-dimensional liquid chromatography apparatus according to the first embodiment will be described below.

Step 1: The gradient pump 4 feeds a mixed solution of the aqueous solution A 1 and the organic solvent solution B 2 (solution B having a higher composition ratio) at a constant flow rate. The auto-sampler 5 injects a certain amount of sample into the flow passage.
Step 2: Components of the injected sample are separated in the normal-phase column 7. The separated components are moved through the column in such an order that the component exhibiting a smaller interaction drifts at a higher speed.
Step 3: The component eluted from the normal-phase column 7 is moved to and retained in the ion-exchange column 9 via the 6-way flow passage switching valve 8. The other component not retained in the ion-exchange column 9 is moved, as it is, to the reversed-phase column 10.
Step 4: The 6-way flow passage switching valve 8 is shifted to switch over the flow passage from the state of FIG. 1A to the state of FIG. 1B. At the same time, the gradient pump 4 feeds the aqueous solution A at a solution composition of 100% to replace the solutions in the ion-exchange column 9 and the reversed-phase column 10 with the aqueous solution A.
Step 5: The gradient pump 4 feeds the aqueous solution C at a solution composition of 100% such that the component retained in the ion-exchange column 9 is eluted and introduced to the reversed-phase column 10. Then, after feeding the aqueous solution A at a solution composition of 100%, the gradient pump 4 feeds the organic solvent solution B at a gradually increasing composition ratio to perform the component separation in the reversed-phase column 10.
Step 6: After completion of the component separation in the reversed-phase column 10, the 6-way flow passage switching valve 8 is shifted to return the flow passage from the state of FIG. 1B to the state of FIG. 1A. At the same time, the gradient pump 4 is operated for returning the solution composition to the same one as that in step 1. Then, steps 3-6 are repeated.

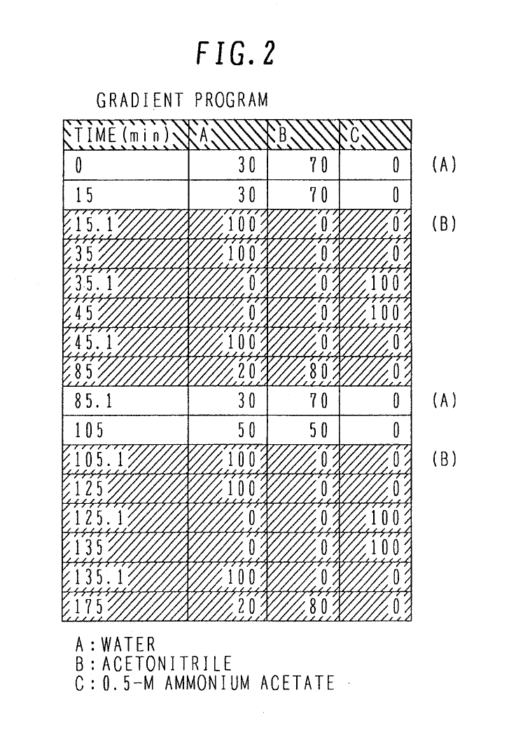

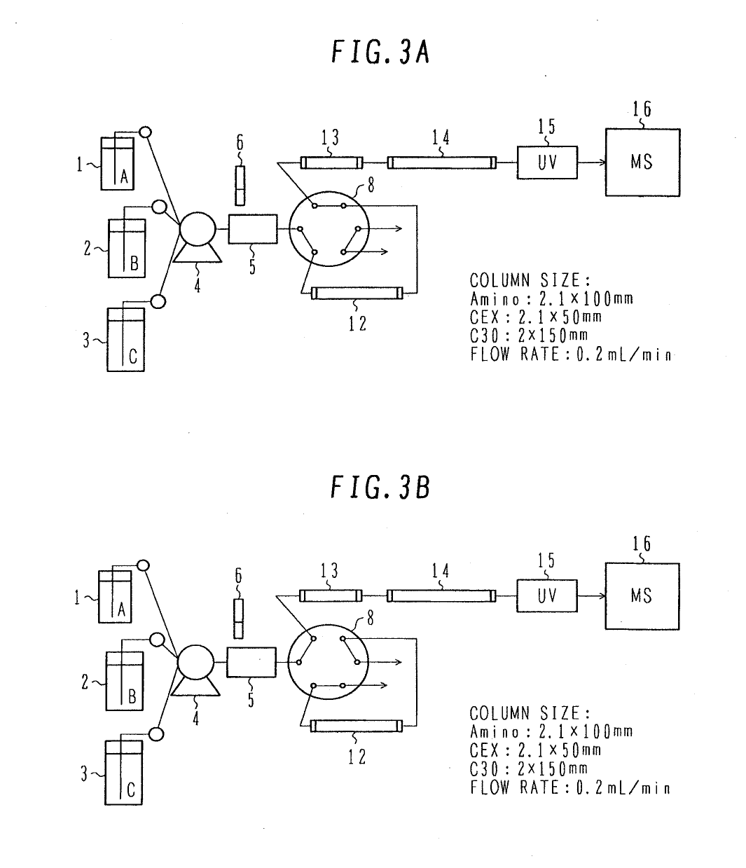

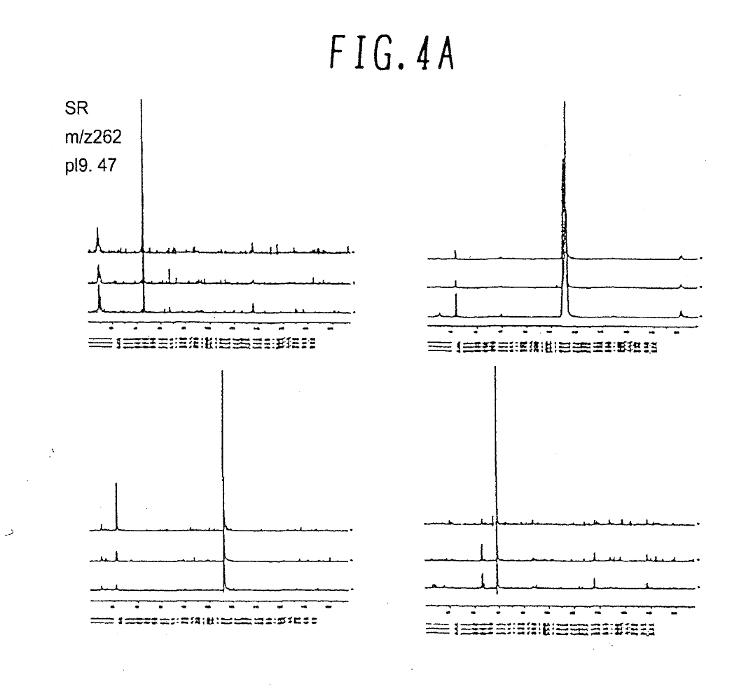

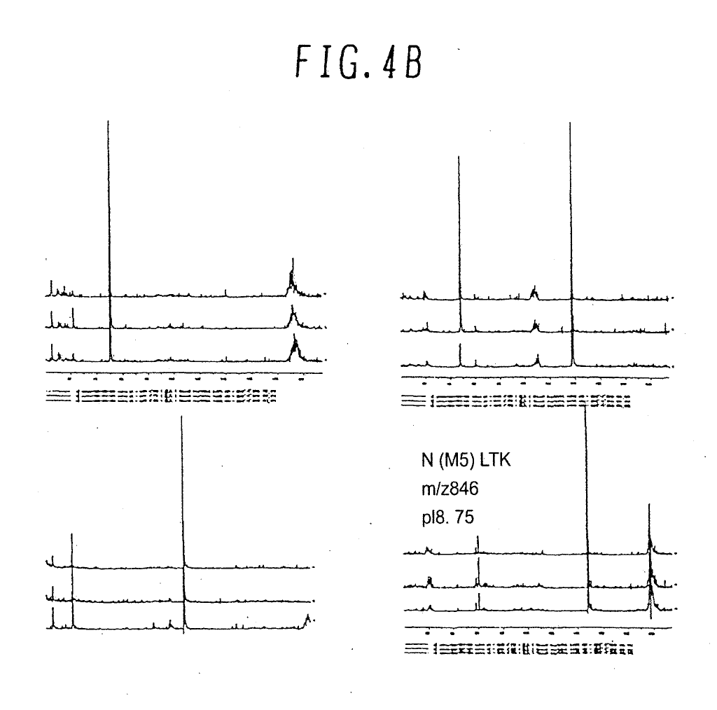

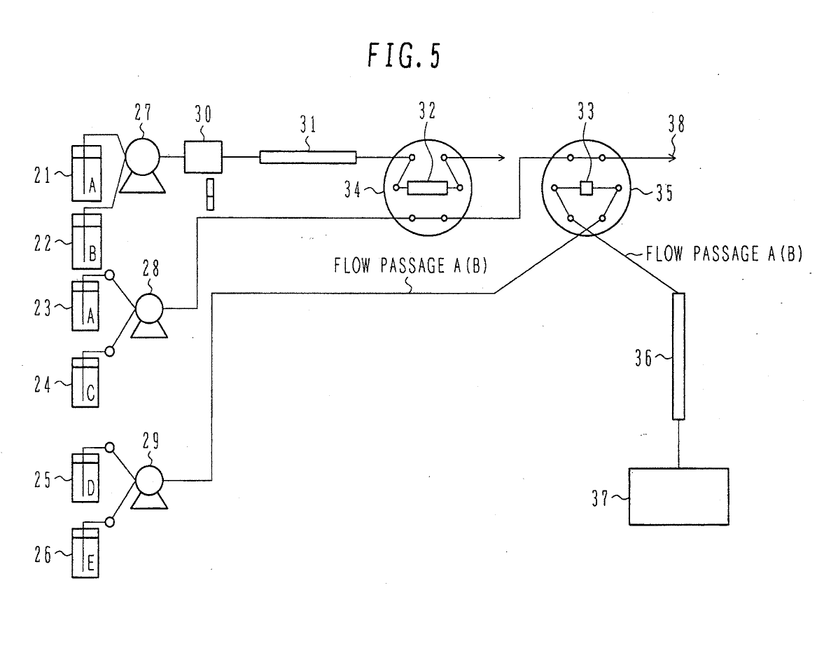

The performance of the three-dimensional liquid chromatography apparatus of the first embodiment was verified as follows. The solutions were fed at a flow rate of 0.2 mL/min while changing the solution composition with time according to a gradient program shown in FIG. 2. The solutions used in experiments were water as the aqueous solution A, acetonitrile as the organic solvent solution B, and 0.5-M ammonium acetate as the aqueous solution C. Also, (A) and (B) in FIG. 2 represent the timing at which the 6-way flow passage switching valve 8 is shifted. Further, FIGS. 3A and 3B show flow passages corresponding to (A) and (B) in FIG. 2, respectively, which are established with a shift of the 6-way flow passage switching valve 8. The sample used in this first embodiment was peptide, shown in Table 2, prepared by digesting ribonuclease B with trypsin. Columns used in this first embodiment were an Amino normal-phase column 12 (2.1×100 mm), a cation-exchange (CEX) column 13 (2.1×50 mm), and a C30 reversed-phase column 14 (2.0×150 mm). The reversed-phase column 14 is connected to the mass spectrometer 16 through the ultraviolet detector 15. FIGS. 4A and 4B are charts showing reproducibility of elution time for six components in Table 2.

TABLE 2

| Mass | Position | Peptide sequence | p1 |
|---|---|---|---|
| 262 | 58-59 | SR | 9.47 |
| 290 | 64-65 | DR | 5.84 |
| 451 | 34-36 | FER | 6.00 |
| 475 | 60-63 | NLTK | 8.75 |
| 590 | 28-33 | ERAAAK | 6.10 |
| 608 | 112-117 | ETGSSK | 6.10 |
| 662 | 125-130 | TTQANK | 8.41 |
| 718 | 58-63 | SRNLTK | 11.00 |
| 846 (2 valences) | 60-63 | NLTK (M5) | |

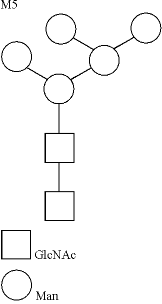

According to this first embodiment, the combination of the normal-phase column and the reversed-phase column, for which the “solution interference” is unavoidable in principle, can be realized with an improvement of a two-dimensional liquid chromatography apparatus.

The separation column of intermediate stage may be a cation- or anion-exchange column. Also, the separation column of intermediate stage may consist of a cation (anion)-exchange column and an anion (cation)-exchange column connected in series. Further, another 6-way flow passage switching valve and a second gradient pump, i.e., a liquid feed unit (means) for mixing and feeding a plurality of solutions, may be additionally connected between the cation (anion)-exchange column and the anion (cation)-exchange column.

### Second Embodiment

FIG. 5 shows a second embodiment of the present invention. The second embodiment differs from the first embodiment in adding two 6-way flow passage switching valves and a reversed-phase trap column so that solutions can be fed at the solution composition suitable for each separation column by using three pumps. The following description is made of primarily points differing from the first embodiment.

A three-dimensional liquid chromatography apparatus of the second embodiment comprises a first gradient pump 27, a second gradient pump 28, an auto-sampler 30 serving as a sample injection unit (means), a normal-phase column 31 serving as a separation column of first stage, a cation (anion)-exchange column 32 serving as a separation column of intermediate stage, a reversed-phase column 36 serving as a separation column of second stage, a first 6-way flow passage switching valve 34, and a mass spectrometer 37. In addition, a second 6-way flow passage switching valve 35 and a third gradient pump 29 are connected between the separation column of intermediate stage and the separation column of second stage.

The first gradient pump 27 is able to mix an aqueous solution A 21 and an organic solvent solution B 22 at a predetermined ratio for the normal-phase column, and to feed the mixed solution to a flow passage.

The second gradient pump 28 is able to mix an aqueous solution A 23 and an aqueous solution C 24 at a predetermined ratio for the ion-exchange column, and to feed the mixed solution to a flow passage.

The third gradient pump 29 is able to mix an aqueous solution D 25 and an organic solvent solution E 26 at a predetermined ratio for the reversed-phase column, and to feed the mixed solution to a flow passage.

The first 6-way flow passage switching valve 34 is able to switch over the flow passage between a flow passage A connecting the first gradient pump 27, the normal-phase column 31 and the ion-exchange column 32 in series and a flow passage B connecting the second gradient pump 28, the ion-exchange column 32 and the second 6-way flow passage switching valve 35 (reversed-phase trap column 33) in series.

The second 6-way flow passage switching valve 35 is able to switch over the flow passage between a flow passage A connecting the third gradient pump 29, the reversed-phase trap column 33 and the reversed-phase column 36 in series, and a flow passage B connecting the first 6-way flow passage switching valve 34 (ion-exchange column 32), the reversed-phase trap column 33 and the reversed-phase column 36 in series.

The operation of the three-dimensional liquid chromatography apparatus according to the second embodiment will be described below.

Step 1: The first gradient pump 27 feeds a mixed solution of the aqueous solution A 21 and the organic solvent solution B 22 (solution B having a higher composition ratio) at a constant flow rate. The auto-sampler 30 injects a certain amount of sample into the flow passage. At that time, the first 6-way flow passage switching valve 34 and the second 6-way flow passage switching valve 35 are each shifted to establish the flow passage A.
Step 2: Components of the injected sample are separated in the normal-phase column 31. The separated components are moved through the column in such an order that the component exhibiting a smaller interaction drifts at a higher speed.
Step 3: The component eluted from the normal-phase column 31 is moved to and retained in the ion-exchange column 32 via the first 6-way flow passage switching valve 34. The other component not retained in the ion-exchange column 32 is discharged to a drain 38. During the same period, the second gradient pump 28 feeds 100% of the aqueous solution A to the ion-exchange column 32, and the third gradient pump 29 feeds 100% of the aqueous solution D to the reversed-phase column 36. The first gradient pump 27 is temporarily stopped here.
Step 4: The first 6-way flow passage switching valve 34 and the second 6-way flow passage switching valve 35 are shifted to switch over the flow passage from A to B. At the same time, the second gradient pump 28 feeds the aqueous solution C at a solution composition of 100%, thus introducing the component trapped in the ion-exchange column 32 to the reversed-phase trap column 33. Thereafter, the first 6-way flow passage switching valve 34 is shifted for return to the flow passage A.
Step 5: The third gradient pump 29 feeds the aqueous solution D and the organic solvent solution E at such a solution composition that a composition ratio of the organic solvent solution E is gradually increased from 100% of the aqueous solution D, thus performing the component separation in the reversed-phase column 36.
Step 6: After completion of the component separation in the reversed-phase column 36, the second 6-way flow passage switching valve 35 is shifted for return to the flow passage A. At the same time, the first gradient pump 27 is operated for returning the solution composition to the same one as that in step 1. Then, steps 3-6 are repeated.

According to this second embodiment, the solution having a high salt concentration and eluted from the ion-exchange column can be prevented from being introduced to the reversed-phase column. When a mass spectrometer is employed as a detector, this second embodiment is effective in increasing detection sensitivity and improving maintainability of the apparatus. Incidentally, the component not retained in the ion-exchange column may flow out to the drain 38.

1. A method for separating a sample in a three-dimensional liquid chromatography apparatus comprising:
mixing a first aqueous solution and an organic solvent solution and injecting a sample into a mixed solution of said aqueous solution by using a liquid feed means;
feeding a mixed solution of said sample, said aqueous solution and said organic solvent solution to a normal phase column connected in series with an ion exchange column and a reverse phase column by using said liquid feed means, to separate components from said sample in said mixed solution;
feeding components eluted from said normal phase column to said ion exchange column, and feeding components eluted from said ion exchange column to said reverse phase column to retain a components of said sample eluted from said ion exchange column in said reverse phase column;
feeding said first aqueous solution to said ion exchange column and said reverse phase column, and replacing said organic solvent solution in said ion exchange column and said reverse phase column with said first aqueous solution fed from said liquid feed means;
feeding a second aqueous solution to said ion exchange column to elute components held in said ion exchange column, and feeding said components eluted from said ion exchange column to said reverse phase column, and feeding said first solution to said reverse phase column, and feeding said organic solvent solution with said first aqueous solution to said reverse phase column; and
gradually increasing a composition ratio of said organic solvent solution to be added to said first aqueous solution to gradually separate components to be separated.

2. The method according to claim 1, wherein said ion exchange column is a cation-exchange column or an anion-exchange column.

3. The method according to claim 1, wherein said ion exchange column consists of a first ion-exchange column and a second ion-exchange column connected in series, wherein ions retained in the first ion-exchange column are one of cations or anions, and ions retained in the second ion-exchange column are the other of cations or anions.

4. The method according to claim 1, which further includes detecting the separated components.

5. A method for separating a sample in a three-dimensional liquid chromatography apparatus comprising:
mixing a first aqueous solution and an organic solvent solution and injecting a sample into a mixed solution of said aqueous solution and said organic solvent solution by using a pump and an auto-sampler;
feeding a mixed solution of said sample, said aqueous solution and said organic solvent solution to a normal phase column connected to a switching valve for selectively connecting and disconnecting said normal phase column to said pump, an ion exchange column and a reverse phase column connected in series with each other to separate components from said sample in said mixed solution;
feeding components eluted from said normal phase column to said ion exchange column, and feeding components eluted from said ion exchange column to said reverse phase column to retain a components of said sample eluted from said ion exchange column, in said reverse phase column;
switching said switching valve to disconnect said normal phase column from said pump, said ion exchange column and said reverse phase column, and feeding said first aqueous solution to said ion exchange column and said reverse phase column, and replacing said organic solvent solution in said ion exchange column and said reverse phase column with said first aqueous solution at a solution composition of 100% fed from said pump; and
feeding a second aqueous solution, including a salt, to said ion exchange column to elute components held in said ion exchange column, and feeding said components eluted from said ion exchange column to said reverse phase column, and feeding said first aqueous solution to said reverse phase column, and feeding said organic solvent solution with said first aqueous solution to said reverse phase column; and
gradually increasing a composition ratio of said organic solvent solution to be added to said first aqueous solution to gradually separate components to be separated.

6. The method according to claim 5, wherein said ion exchange column is a cation-exchange column or an anion-exchange column.

7. The method according to claim 5, wherein said ion exchange column consists of a first ion-exchange column and a second ion-exchange column connected in series, wherein ions retained in the first ion-exchange column are one of cations or anions, and ions retained in the second ion-exchange column are the other of cations or anions.

8. The method according to claim 5, which further includes detecting the separated components.
